(19) United States
(12) Patent Application Publication
(10) Pub. No.: US 2012/0050341 A1
(43) Pub. Date: Mar. 1, 2012

(54) TWO MODE IMAGE DISPLAYING APPARATUS AND ADJUSTMENT METHOD OF IMAGE BRIGHTNESS

(75) Inventors: Chi-Lin Wu, Taipei County (TW); Wei-Ting Yen, Taipei City (TW); Kuen Lee, Hsinchu City (TW); Lang-Chin Lin, Hsinchu City (TW); Chun-Jung Chen, Hsinchu County (TW)

(73) Assignee: INDUSTRIAL TECHNOLOGY RESEARCH INSTITUTE, Hsinchu (TW)

(21) Appl. No.: 12/978,408

(22) Filed: Dec. 24, 2010

(30) Foreign Application Priority Data
Aug. 30, 2010 (TW) 99129123

(51) Int. Cl. G09G 5/10

(52) U.S. Cl. 345/690

(57) ABSTRACT

A two mode image displaying apparatus including a light source, an image dividing unit, a displaying unit, and a control unit is provided. The light source is adapted to provide a light beam. The image dividing unit is adapted to be switched to include a three-dimensional (3D) mode area and a two-dimensional (2D) mode area. The light source is adapted to be switched to include a first area and a second area. The image dividing unit and the displaying unit are disposed on the transmission path of the light beam. The control unit executes a boundary brightness compensation by adjusting brightness of at least one of the boundary of a 3D image area and a 2D image area of the displaying unit and the boundary of the first and second areas of the light source. An adjustment method of image brightness is also provided.

### CROSS-REFERENCE TO RELATED APPLICATION

This application claims the priority benefit of Taiwan application serial no. 99129123, filed on Aug. 30, 2010. The entirety of the above-mentioned patent application is hereby incorporated by reference herein and made a part of this specification.

### BACKGROUND

1. Technical Field

The disclosure relates to a display and an adjustment method of brightness, and more particularly to a two mode image displaying apparatus and an adjustment method of image brightness.

2. Description of Related Art

As display technology advances rapidly, visual effects that are increasingly lifelike and realistic are continually being discovered, bringing a user visual experiences that are fresh, lively, and extremely stunning. In recent years, stereoscopic display technologies are spreading from the theaters to typical homes. Consequently, stereoscopic display apparatuses or stereoscopic televisions are subjects of competitive research focuses for major international display manufacturers.

When viewing stereoscopic films with conventional stereoscopic display techniques, the user must wear specially made eyeglasses to filter the left eye image and the right eye image, such that the left eye merely sees the left eye image, the right eye merely sees the right eye image, and accordingly a stereoscopic visual effect is generated in the user's brain. However, inconveniences arise when the user has to wear the specially made eyeglasses. For example, for users who normally wear spectacles for near-sightedness or far-sightedness, having to wear an extra pair of specially made eyeglasses can be uncomfortable, since the weight of two pairs of eyeglasses are placed on the bridge of the nose and the ears. Moreover, the size of the near-sighted or far-sighted spectacles is typically not matched with the size of the specially made eyeglasses, and so the eyeglasses slip easily due to unbalanced wear.

Therefore, auto-stereoscopic display technologies have been developed to solve the issues of the stereoscopic display technologies which require users to wear eyeglasses. Conventional auto-stereoscopic display technologies typically employ parallax barriers or lenticular lens films to separate the left eye image beam and the right eye image beam. Accordingly, even if the user does not wear specially made eyeglasses, the left eye merely sees the left eye image, whereas the right eye merely sees the right eye image, and accordingly a stereoscopic visual effect is generated in the user's brain with the left and right eye images.

### SUMMARY

A two mode image displaying apparatus is introduced in an embodiment of the disclosure, including a light source, an image dividing unit, a displaying unit, and a control unit. The light source is adapted to provide a light beam. The image dividing unit is disposed on a transmission path of the light beam. The image dividing unit is adapted to be switched to include a three-dimensional (3D) mode area and a two-dimensional (2D) mode area, and the light source is adapted to be switched to include a first area corresponding to the 3D mode area and a second area corresponding to the 2D mode area. The first area has a first average brightness, the second area has a second average brightness, and the first average brightness is not equal to the second average brightness. The displaying unit is disposed on the transmission path of the light beam. The displaying unit is adapted to display a 3D image in a 3D image area, and to display a 2D image in a 2D image area. The 3D image area corresponds to the 3D mode area, and the 2D image area corresponds to the 2D mode area. The control unit is electrically connected to the light source, the image dividing unit, and the displaying unit. The control unit executes a boundary brightness compensation by adjusting a brightness of at least one of the boundary of the 3D image area and the 2D image area and the boundary of the first area and the second area, for reducing a boundary brightness difference between a 3D output image and a 2D output image provided by the two mode image displaying apparatus.

Another embodiment of the disclosure provides an adjustment method of image brightness, including the following steps. A light source is used to provide a light beam to an image dividing unit and a displaying unit. Moreover, the image dividing unit is switched to include a 3D mode area and a 2D mode area. In addition, on the displaying unit a 3D image is displayed in a 3D image area and a 2D image is displayed in a 2D image area, in which the 3D image area corresponds to the 3D mode area, and the 2D image area corresponds to the 2D mode area. Further, a first area of the light source is configured to have a first average brightness, and a second area of the light source is configured to have a second average brightness, in which the first area corresponds to the 3D mode area, the second area corresponds to the 2D mode area, and the first average brightness is not equal to the second average brightness. Moreover, a boundary brightness compensation is executed by adjusting a brightness of at least one of the boundary of the 3D image area and the 2D image area and the boundary of the first area and the second area, for reducing a boundary brightness difference between a 3D output image and a 2D output image outputted by the light source, the image dividing unit, and the displaying unit as a whole.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic cross-sectional view of a two mode image displaying apparatus according to an embodiment of the disclosure.

FIG. 2 is a front view of a microretarder unit depicted in FIG. 1.

FIG. 3 are front views illustrating a first area, a second area, a three-dimensional (3D) mode area, a two-dimensional (2D) mode area, a 3D image area, and a 2D image area depicted in FIG. 1 and the corresponding relationships therebetween.

FIG. 4 illustrates an adjustment of image brightness executed by a control unit depicted in FIG. 1.

FIGS. 5A-5C illustrate curve diagrams of gamma conversions.

FIG. 6 illustrates an adjustment of image brightness executed by a control unit of a two mode image displaying apparatus according to another embodiment of the disclosure.

FIG. 7 illustrates an adjustment of image brightness executed by a control unit of a two mode image displaying apparatus according to yet another embodiment of the disclosure.

FIG. 8 is a schematic cross-sectional view of a pixel array and an image dividing unit of a two mode image displaying apparatus according to another embodiment of the disclosure.

FIG. 9 is a schematic cross-sectional view of a two mode image displaying apparatus according to another embodiment of the disclosure.

FIG. 10 illustrates an adjustment of image brightness executed by a control unit depicted in FIG. 9.

FIG. 11 is a flow chart illustrating an adjustment method of image brightness according to an embodiment of the disclosure.

### DESCRIPTION OF EMBODIMENTS

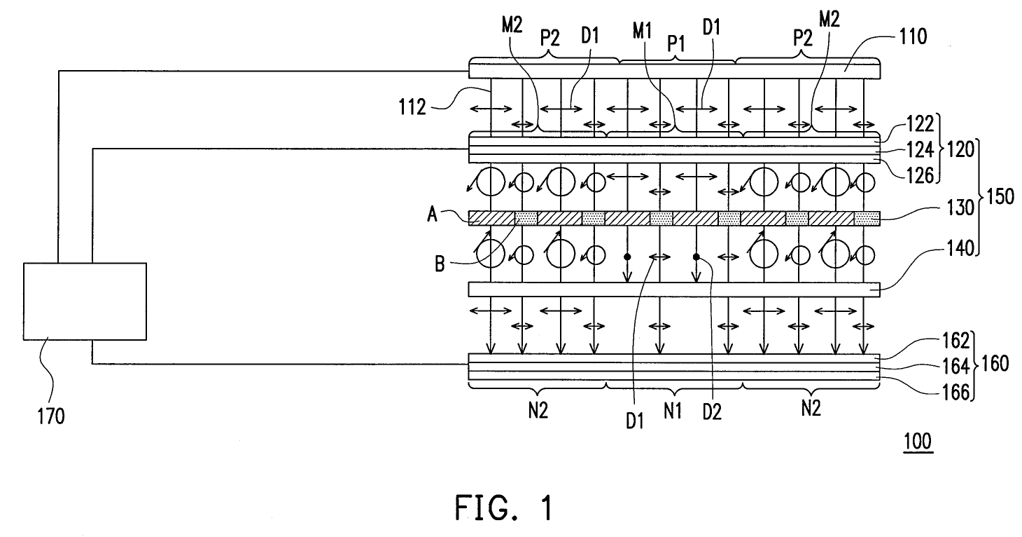

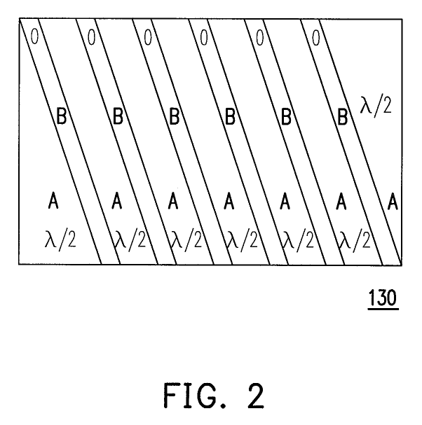

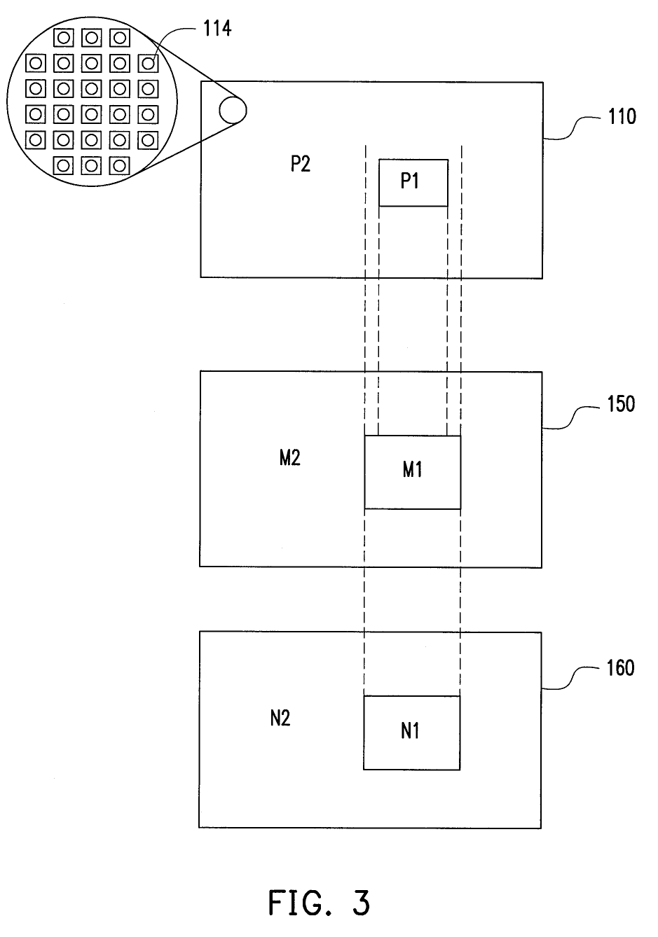

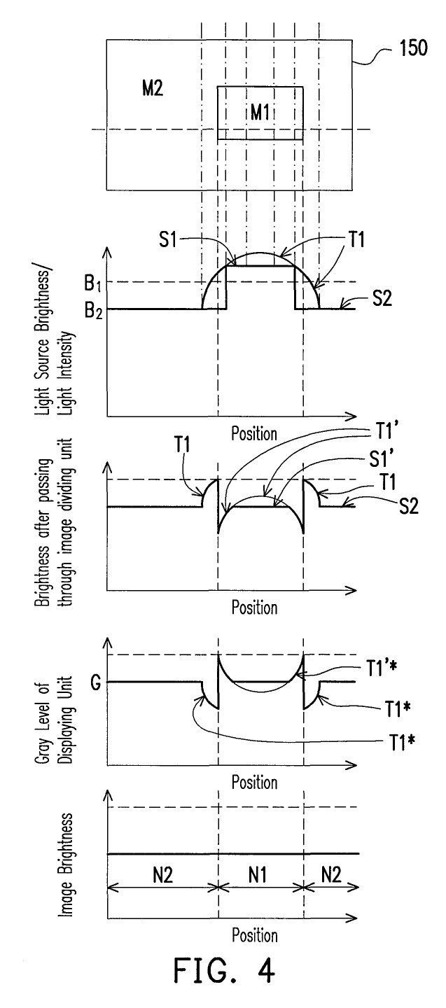

FIG. 1 is a schematic cross-sectional view of a two mode image displaying apparatus according to an embodiment of the disclosure. FIG. 2 is a front view of a microretarder unit depicted in FIG. 1. FIG. 3 are front views illustrating a first area, a second area, a three-dimensional (3D) mode area, a two-dimensional (2D) mode area, a 3D image area, and a 2D image area depicted in FIG. 1 and the corresponding relationships therebetween. FIG. 4 illustrates an adjustment of image brightness executed by a control unit depicted in FIG. 1. Referring to FIGS. 1-4, an embodiment provides a two mode image displaying apparatus 100 comprising a light source 110, an image dividing unit 150, a displaying unit 160, and a control unit 170. The light source 110 is adapted to provide a light beam 112. In the embodiment, the light source 110 is a polarized light source, and the light beam 112 is a polarized light beam, for example. For instance, the light beam 112 is a linearly polarized light beam having a first polarized direction D1.

The image dividing unit 150 is disposed on a transmission path of the light beam 112. In the embodiment, the image dividing unit 150 comprises a liquid crystal panel 120, a microretarder unit 130, and a polarizing film 140. In the embodiment, the liquid crystal panel 120 comprises an active device array substrate 122, a liquid crystal layer 124, and an opposite substrate 126, and the liquid crystal layer 124 is disposed between the active device array substrate 122 and the opposite substrate 126. In the embodiment, the microretarder unit 130 has an A area retarding material and a B area retarding material. The A area retarding material may generate λ/2 phase retardation (i.e., half of a wavelength of phase retardation, where λ represents a wavelength), for example, and the B area retarding material may generate 0λ phase retardation (i.e., no phase retardation), for instance.

Moreover, the image dividing unit 160 is disposed on the transmission path of the light beam 112. In the embodiment, the displaying unit 160 is, for example, a liquid crystal panel comprising an active device array substrate 162, a liquid crystal layer 164, and an opposite substrate 166, and the liquid crystal layer 164 is disposed between the active device array substrate 162 and the opposite substrate 166. The active device array substrate 162 is, for example, a thin film transistor substrate, and the opposite substrate 166 is, for instance, a color filter substrate. In the embodiment, an extended direction of the B area retarding material inclines relative to an arranged direction of the pixel array in the displaying unit 160. More specifically, the extended direction of the B area retarding material inclines relative to an edge of the microretarder unit 130. The pixel array of the displaying unit 160 is arranged into a plurality of rows and columns along a direction parallel or perpendicular to the edge of the microretarder unit 130. Therefore, the extended direction of the B area retarding material inclines relative to the arranged direction of the pixel array in the displaying unit 160. However, in other embodiments, the extended directions of the A area retarding material and the B area retarding material may be parallel or perpendicular to the arranged direction of the pixel array in the displaying unit 160.

The image dividing unit 150 is adapted to be switched to comprise a 3D mode area M1 and a 2D mode area M2. In the embodiment, the control unit 170 is adapted to transmit a control signal to the image dividing unit 150, so as to switch the image dividing unit 150 to comprise the 3D mode area M1 and the 2D mode area M2. For example, the liquid crystal layer 124 in the 3D mode area M1 may be switched to a state which does not generate phase retardation (i.e., generating 0λ phase retardation). At this time, after the light beam 112 from the light source 110 passes through the portion of liquid crystal panel 120 located at the 3D mode area M1, the polarization direction of the light beam 112 from the light source 110 has not been altered, and remains in the first polarization direction D1. Next, after the light beam 112 passes through the A area phase retarding material in the 3D mode area M1, due to the A area having a λ/2 phase retardation, the polarization direction of the light beam 112 is transformed from the first polarization direction D1 into a second polarization direction D2, in which the second polarization direction D2 is substantially perpendicular with the first polarization direction D1. In the embodiment, the polarizing film 140 is adapted to block light having the second polarization D2 and adapted to pass through light having the first polarization direction D1. Therefore, after the light beam 112 passes through the A area phase retarding material in the 3D mode area M1, the light beam 112 is blocked by the polarizing film 140. On the other hand, after the light beam 112 passes through the B area phase retarding material in the 3D mode area M1, due to the B area having no phase retardation, the polarization direction of the light beam 112 remains in the first polarization direction D1. Accordingly, the light beam 112 can be transmitted to the displaying unit 160 by passing through the polarizing film 140.

Since the light beam 112 passing through the A area phase retarding material in the 3D mode area M1 is blocked by the polarizing film 140 and thus cannot be transmitted to the displaying unit 160, and the light beam 112 passing through the B area retarding material in the 3D mode area M1 passes through the polarizing film 140 and is thus successfully transmitted to the displaying unit 160, accordingly the 3D mode area M1 can achieve an effect of parallax barrier.

The displaying unit 160 is adapted to display a 3D image in a 3D image area N1, and the effect of parallax barrier formed by the 3D mode area M1 can result in the user's left and right eye respectively seeing different left and right eye images, and thus generating the stereoscopic visual effect in the user's brain. The 3D image area N1 corresponds to the 3D mode area M1. In the embodiment, the 3D image area N1 directly corresponds to the 3D mode area M1.

The liquid crystal layer 124 in the 2D mode area M2 may be switched to a state generating λ/4 phase retardation. In the embodiment, the control unit 170 is adapted to transmit the control signal to the image dividing unit 150, so as to switch the liquid crystal layer 124 in the 2D mode area M2 to the state generating λ/4 phase retardation. At this time, after the light beam 112 from the light source 110 passes through the portion of liquid crystal panel 120 located at the 2D mode area M2, the polarization state of the light beam 112 from the light source 110 transforms from a linearly polarized state to a circularly polarized state. Next, after the light beam 112 passes through the A area phase retarding material in the 2D mode area M2, due to the A area having a λ/2 phase retardation, the polarization direction of the light beam 112 is transformed from the circularly polarized state depicted in FIG. 1 into another circularly polarized state in an opposite direction. Thereafter, the light beam 112 having the other circularly polarized state partially passes through the polarizing film 140, is transformed into a linearly polarized light beam 112 having the first polarization direction D1, and transmitted to the displaying unit 160. On the other hand, after the light beam 112 passes through the B area phase retarding material in the 2D mode area M2, due to the B area having no phase retardation, the polarization state of the light beam 112 remains in the original circularly polarized state. Next, the light beam 112 having the circularly polarized state partially passes through the polarizing film 140, is transformed into a linearly polarized light beam 112 having the first polarization direction D1, and transmitted to the displaying unit 160. Since a portion of either the light beam passing through the A area or the B area in the 2D mode area M2 reaches the displaying unit 160, the 2D mode area M2 does not form the effect of parallax barrier. Rather, the 2D mode area M2 serves as a typical light transmissive region.

The displaying unit 160 is adapted to display a 2D image in a 2D image area N2, and the non-parallax barrier and light transmissive effect of the 2D mode area M2 concurrently transmits the 2D image of the displaying unit 160 to the user's left and right eyes, and accordingly generates a non-stereoscopic, plane visual effect in the user's brain. The 2D image area N2 corresponds to the 2D mode area M2. In the embodiment, the 2D image area N2 directly corresponds to the 2D mode area M2, for example.

In the embodiment, the image dividing unit 150 is disposed between the light source 110 and the displaying unit 160. However, in other embodiments, the displaying unit 160 may be disposed between the light source 110 and the image dividing unit 150, and under this condition, the two mode image displaying apparatus can still display 2D and 3D images at the same time.

The light source 110 is adapted to be switched to comprise a first area P1 corresponding to the 3D mode area M1, and a second area P2 corresponding to the 2D mode area M2. In the embodiment, the control unit 170 is adapted to transmit a control signal to the light source 110, so as to switch the light source 110 to comprise the first area P1 and the second area P2. The first area P1 has a first average brightness B₁ (referring to FIG. 4), the second area P2 has a second average brightness B₂, and the first average brightness B₁ is not equal to the second average brightness B₂. In the embodiment, the first average brightness B₁ is greater than the second average brightness B₂. In FIG. 4, a line segment S1 represents a driving brightness of the first area P1, and a curve T1 represents a light intensity experienced in and around the first area P1, which is similar to a Lambertian distribution. Moreover, a line segment S2 represents a driving brightness of the second area P2.

In the embodiment, the light source 110 comprises a self-luminescent device array, in which a plurality of self-luminescent devices 114 are arranged in an array (as shown in FIG. 3). Further, in the present embodiment, the self-luminescent device array is a pixelized self-luminescent device array. Pixelized refers to, for example, the size and dimension for each of the self-luminescent devices 114 approaches or equals the pixel size in the displaying unit 160. Moreover, the self-luminescent devices 114 directly correspond to the pixels in the displaying unit 160, for example. However, in other embodiments, the self-luminescent device array may also be non-pixelized self-luminescent device array, in which the size of the self-luminescent devices are larger than the pixels in the displaying unit 160. In addition, the self-luminescent device array is, for example, a light emitting diode (LED) array, an organic light emitting diode (OLED) array, or a plasma display unit array.

When the light source 110 employs the self-luminescent device array, the brightness generated by the light source 110 is not as smooth and continuous as represented by the line segments S1 and S2, if examined microscopically. However, the line segments S1 and S2 are used to represent a macroscopic effect. Since the brightness detected by the human eye is closer to the macroscopic effect, therefore the specification uses line segments to macroscopically represent the brightness of the first area M1 and the second area M2.

After the light beam 112 passes through the image dividing unit 150, due to the 3D mode area M1 blocking more light, the brightness of the 3D mode area M1 is reduced. Accordingly, the line segment S1 and the curve T1 in the 3D mode area M1 are moved downward to the positions of a line segment S1′ and a curve T1′, whereas the positions of the line segment S2 and the curve T1 in the 2D mode area M2 remain substantially the same. In the embodiment, the control unit 170 is electrically connected to the light source 110. The control unit 170 can suitably adjust the first average brightness B₁ and the second average brightness B₂, such that after the light beam 112 passes through the image dividing unit 150, the line segment S1′ and the line segment S2 are substantially on a same horizontal line.

Moreover, the control unit 170 is electrically connected to the image dividing unit 150 and the displaying unit 160. The control unit 170 executes a boundary brightness compensation by adjusting a brightness of at least one of the boundary of the 3D image area N1 and the 2D image area N2 and the boundary of the first area P1 and the second area P2, for reducing a boundary brightness difference between a 3D output image and a 2D output image provided by the two mode image displaying apparatus 100.

In the embodiment, the control unit 170 executes the boundary brightness compensation by adjusting the brightness of the boundary of the 3D image area N1 and the 2D image area N2. More specifically, in the embodiment, the boundary brightness compensation executed by the control unit 170 comprises lowering a gray level of the boundary of the 2D image displayed by the displaying unit 160 adjacent to the 3D image, for example by lowering to the gray level represented by a curve T1*, in which the curve T1* represents the curve T1 flipped upside down. In the embodiment, the control unit 170 employs a gamma conversion of a gamma value greater than 1 to lower the gray level of the boundary of the 2D image adjacent to the 3D image. In other words, the gray level is lowered from G to the gray level represented by the curve T1*.

A formula for the gamma conversion may be as follows:

$$J = low\_out + ( high\_out - low\_out ) \times {( \frac{I - low\_in}{high\_in - low\_in} )}^{gamma}$$

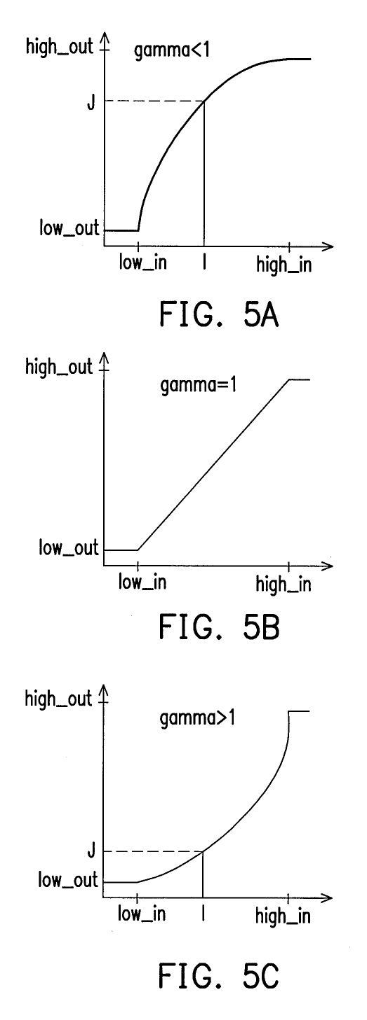

Curve diagrams of gamma conversions are illustrated in FIGS. 5A-5C. FIG. 5A illustrates a conversion curve when the gamma value is less than 1, FIG. 5B illustrates a conversion curve when the gamma value is equal to 1, and FIG. 5C illustrates a conversion curve when the gamma value is greater than 1. low_in represents a lowest input value to proceed with the gamma conversion, high_in represents a highest input value to proceed with the gamma conversion, gamma represents the gamma value, low_out represents a lowest output value after proceeding with the gamma conversion, high_out represents a highest output value after proceeding with the gamma conversion, I represents an input value to proceed with the gamma conversion, and J represents an output value obtained after proceeding with the gamma conversion of the input value I.

In the embodiment, an area of the first area P1 is smaller than an area of the 3D mode area M1, and the area of the 3D mode area M1 is substantially equal to an area of the 3D image area N1. Moreover, the boundary brightness compensation executed by the control unit 170 comprises increasing a gray level of the boundary of the 3D image adjacent to the 2D image, for example by increasing the gray level G to the gray level represented by a curve T1′*, in which the curve T1′* represents the curve T1′ flipped upside down. In the embodiment, the control unit 170 employs a gamma conversion of a gamma value less than 1 to increase the gray level of the boundary of the 3D image adjacent to the 2D image.

Since the curve T1* represents the curve T1 flipped upside down, and the curve T1′* represents the curve T1′ flipped upside down, therefore after the light beam 112 passes through the image dividing unit 150 and the displaying unit 160, the curve T1* compensates the curve T1, and the curve T1′* compensates the curve T1′. Therefore, the brightness of the 3D output image (e.g., an image located in the 3D image area N1 depicted in FIG. 4) outputted by the two mode image displaying apparatus 100 substantially matches with the brightness of the 2D output image (e.g., an image located in the 2D image area N2 depicted in FIG. 4). Moreover, the boundaries of the 3D output image and the 2D output image (e.g., the boundaries of the 3D image area N1 and the 2D image area N2 depicted in FIG. 4) do not generate a unsuitable brightness difference to be experienced by the user.

In the embodiment, the control unit 170 is adapted to dynamically adjust positions and sizes of the 3D mode area M1 and the 2D mode area M2, and to correspondingly adjust positions and sizes of the first area P1, the second area P2, the 3D image area N1, and the 2D image area N2. In other words, the positions and sizes of the 3D mode area M1 and the 2D mode area M2 may be freely changed, such that the positions and sizes of the 3D output image and the 2D output image may be freely changed according to a requirement. Moreover, the size of the 3D mode area M1 may be changed to 0, and at this time the two mode image displaying apparatus merely displays the 2D output image, but does not display the 3D output image. On the other hand, the size of the 2D mode area M2 may also be changed to 0, and at this time the two mode image displaying apparatus merely displays the 3D output image, but does not display the 2D output image. In addition, the quantity of the 3D mode area M1, the 2D mode area M2, the first area P1, the second area P2, the 3D image area N1, and the 2D image area N2 may be changed according to a requirement, for instance to a plurality of areas. For example, the quantity of the 3D mode area M1 may be one or a plurality. Moreover, the quantity of the 2D mode area M2 may also be one or a plurality. In addition, the quantity of the first area P1, the second area P2, the 3D image area N1, and the 2D image area N2 corresponds to the quantity of the 3D mode area M1 and the 2D mode area M2.

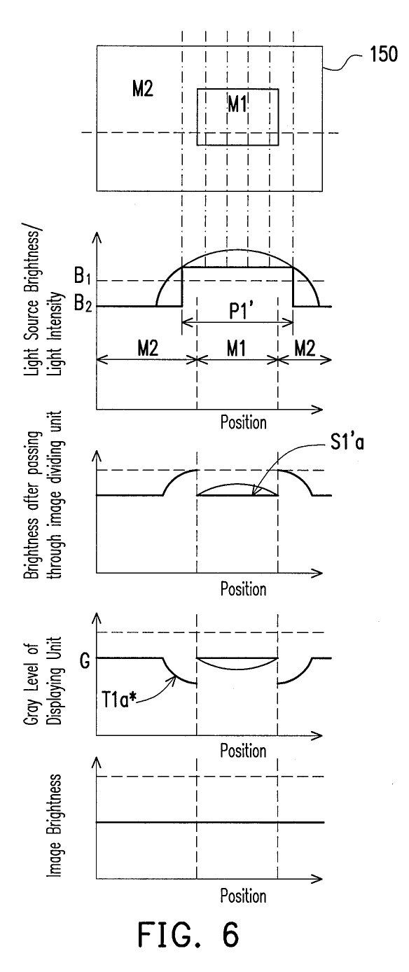

FIG. 6 illustrates an adjustment of image brightness executed by a control unit of a two mode image displaying apparatus according to another embodiment of the disclosure. Referring to FIG. 6, the two mode image displaying apparatus of the present embodiment is similar to the two mode image displaying apparatus 100 depicted in FIG. 1, and a difference therebetween is described as below. In the embodiment, the area of a first area P1′ of the light source 110 is larger than that of the 3D mode area M1, hence after the light beam 112 passes through the image dividing unit 150, the boundary in the first mode area M1 adjacent to the second mode area M2 does not generate a curve lower than a line segment S1′a (e.g., the curve T1′ located at the two sides of the line segment S1′ depicted in FIG. 4 is not generated). Accordingly, the control unit 170 may lower the gray level of the boundary of the 2D image adjacent to the 3D image by adjusting to the gray level represented by the curve T1a*. For example, a gamma conversion of a gamma value greater than 1 can be employed to lower the gray level of the boundary of the 2D image adjacent to the 3D image, and the gray level of the boundary of the 3D image adjacent to the 2D image does not need to be increased. Accordingly, the two mode image displaying apparatus can provide 3D and 2D output images having a substantially more uniform brightness, and the brightness difference of the boundary of the 3D and 2D output images can be effectively lowered.

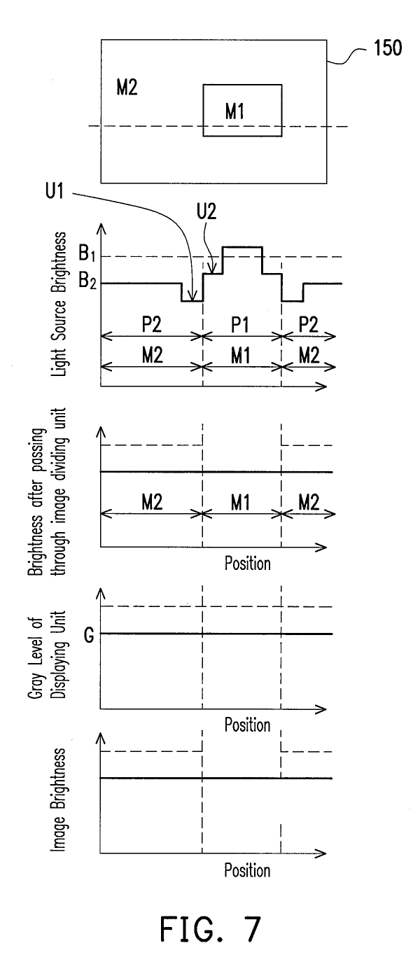

FIG. 7 illustrates an adjustment of image brightness executed by a control unit of a two mode image displaying apparatus according to yet another embodiment of the disclosure. Referring to FIG. 7, the two mode image displaying apparatus of the present embodiment is similar to the two mode image displaying apparatus 100 depicted in FIG. 1, and a difference therebetween is described as below. In the embodiment, the control unit 170 executes the boundary brightness compensation by adjusting the brightness of the boundary of the first area P1 and the second area P2 of the light source 110. More specifically, in the embodiment, the boundary brightness compensation executed by the control unit 170 comprises lowering a brightness (e.g., the brightness represented by a line segment U1) of the boundary of the second area P2 adjacent to the first area P1 to be slightly lower than the second average brightness B₂, and increasing a brightness (e.g., the brightness represented by a line segment U2) of the boundary of the first area P1 adjacent to the second area P2 to be slightly higher than the second average brightness B₂. The brightness refers to the driving brightness of the light source 110, and not to the light intensity experienced by observing the light source 110. Since the control unit 170 commands the light source 110 to perform the brightness compensation in advance, therefore after the light beam 112 passes through the image dividing unit 150, a uniform brightness distribution is generated with the same brightness between the 3D mode area M1 and the 2D mode area M2. Moreover, the boundary brightness difference between the 3D mode area M1 and the 2D mode area M2 can be effectively reduced, as shown by the second coordinate diagram in FIG. 7 counting from the top.

Since a uniform brightness distribution can be generated after the light beam 112 passes through the image dividing unit 150, the gray level of the displaying unit 160 may not require adjustment, as shown by the third coordinate diagram in FIG. 7 counting from the top. Under this condition, the 3D and 2D output images ultimately displayed by the two mode image displaying apparatus are substantially more uniform, and the boundary brightness difference therebetween may be effectively reduced, as shown by the bottommost coordinate diagram in FIG. 7.

In the disclosure, the image dividing unit employed by the two mode image displaying apparatus is not limited to the image dividing unit 150 depicted in FIG. 1. In other embodiments of the disclosure, any image dividing unit capable of generating 2D and 3D imaging effects may be adopted. Two embodiments are described hereinafter to illustrate other types of image dividing units, although the disclosure should be construed as limited thereto.

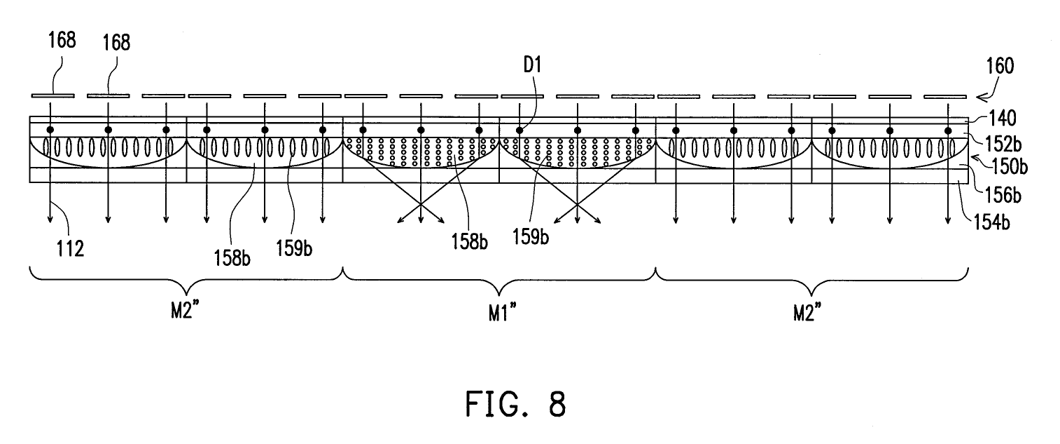

FIG. 8 is a schematic cross-sectional view of a pixel array and an image dividing unit of a two mode image displaying apparatus according to another embodiment of the disclosure. Referring to FIG. 8, the two mode image displaying apparatus of the present embodiment is similar to the two mode image displaying apparatus 100 depicted in FIG. 1, and a difference therebetween is in the type and positioning of the image dividing unit. In the embodiment, the light beam 112 first passes through a pixel array 168 of the displaying unit 160, and then passes through an image dividing unit 150b. Moreover, in the embodiment, the image dividing unit 150b comprises a polarizing film 140, a first transparent substrate 152b, a second transparent substrate 154b, a plurality of concave lenses 156b, and a liquid crystal layer 158b having a plurality of liquid crystal molecules 159b. The concave lenses 156b are disposed between the first transparent substrate 152b and the second transparent substrate 154b. The liquid crystal layer 158b is filled in a space formed between the concave lenses 156b and the first transparent substrate 152b. After the light beam 112 passes through the polarizing film 140, the light beam 112 has the first polarization direction D1. In the embodiment, the first transparent substrate 152b and the second transparent substrate 154b in a 3D mode area M1″ are not applied with voltages, and thus the liquid crystal molecules 159b are in a level state, with an extended direction thereof parallel to the first polarization direction D1. Since the refractive indices on the extended direction of the liquid crystal molecules 159b and on a direction perpendicular to the extended direction (e.g., perpendicular to the first polarization direction D1 and parallel to the first transparent substrate 152b) are not the same, and the refractive index on the extended direction is higher than the refractive index of the concave lenses 156b, therefore the light beam 112 is first condensed and thereafter dispersed. The concave lenses 156b are, for example, lenticular lenses. Therefore, the image dividing unit 150b in the 3D mode area M1″ may be configured as a lenticular lens film capable of generating 3D image effect, so as to separately transmit the right eye image to user's right eye and transmit the left eye image to the user's left eye, thereby achieving the 3D visual effect.

On the other hand, a voltage difference is applied between the first transparent substrate 152b and the second transparent substrate 154b in a 2D mode area M2″, and thus the liquid crystal molecules 159b are in a vertical state (e.g., the liquid crystal molecules 159b are substantially perpendicular to the first transparent substrate 152b). Since the refractive index on the direction perpendicular to the extended direction of the liquid crystal molecules 159b is substantially the same as the refractive index of the concave lenses, therefore the interface of the liquid crystal layer 158b and the concave lenses 156b does not, in essence, generate a refractive effect. Accordingly, the light beam 112 is not condensed and dispersed. Hence, the effect of the image dividing unit 150b in the 2D mode area M2″ is similar to a transparent plate. Therefore, after the light beam 112 passes through the 2D mode area M2″, a 2D image without the stereoscopic effect is generated.

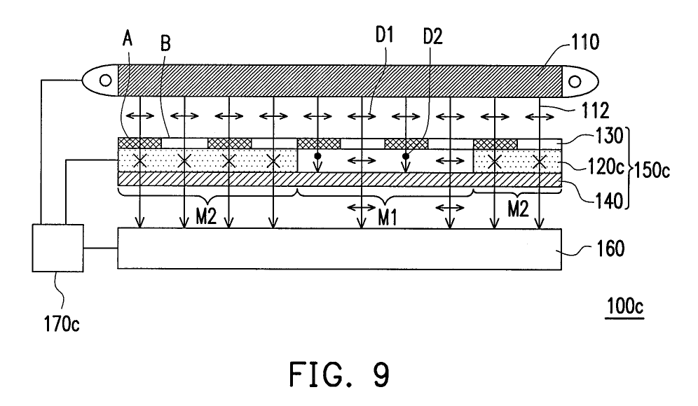

FIG. 9 is a schematic cross-sectional view of a two mode image displaying apparatus according to another embodiment of the disclosure. Referring to FIG. 9, a two mode image displaying apparatus 100c of the present embodiment is similar to the two mode image displaying apparatus 100 depicted in FIG. 1, and a difference therebetween is in the image displaying unit and the control method of the control unit. In the embodiment, a liquid crystal layer 120c of an image dividing unit 150c comprises polymer dispersed liquid crystals (PDLCs) or polymer network liquid crystals (PNLCs). Therefore, when two sides of the liquid crystal layer 120c are applied with a voltage difference, the liquid crystal layer 120c forms a murky state and obtains a light scattering effect. However, when two sides of the liquid crystal layer 120c are not applied with a voltage difference, the liquid crystal layer 120c forms a clear state and obtains a transparent effect.

In the embodiment, the liquid crystal layer 120c in the 3D mode area M1 are not applied with voltages. Therefore, the polarization direction of the light beam 112 passing through the A area phase retarding material in the 3D mode area M1 transforms from the first polarization direction D1 to the second polarization direction D2, and accordingly the light beam 112 is blocked by the polarizing film 140 after passing through the clear liquid crystal layer 120c. On the other hand, the polarization direction of the light beam 112 passing through the B area phase retarding material in the 3D mode area M1 maintains in the first polarization direction D1, and accordingly the light beam 112 passes through the polarizing film 140 after passing through the clear liquid crystal layer 120c. Therefore, the image dividing unit 150c in the 3D mode area M1 is capable of generating an effect similar to a parallax barrier. On the other hand, the liquid crystal layer 120c in the 2D mode area M2 is applied with a voltage difference and forms a murky state. Accordingly, in the 2D mode area M2, whether the light beam 112 passed through the A area phase retarding material or the B area phase retarding material, after passing through the liquid crystal layer 120c in the murky state, the light scattering effect of the liquid crystal layer 120c causes the light beam 112 to not have a polarization property. In FIG. 9, the lack of the polarization property is denoted by a “x” symbol. Therefore, a portion of the light beam 112 (e.g., the portion in the light beam 112 having the first polarization direction D1) can subsequently pass through the polarizing film 140, and accordingly the image dividing unit 150c in the 2D mode area M2 has an effect similar to a neutral density filter, which is partially transmissive.

Due to the scattering effect of the murky liquid crystal layer 120c in the 2D mode area M2, the brightness of the light beam 112 is reduced. Moreover, the light beam 112 which passed through the murky liquid crystal layer 120c has no polarization direction, and after the light beam 112 passes through the polarizing film 140, the brightness of the light beam 112 is approximately reduced by half. Therefore, the degree of brightness reduction of the light beam 112 from the light source 110 after passing through the 2D mode area M2 is larger than the degree of brightness reduction after passing through the 3D mode area M1, and this situation is reversed from the embodiment illustrated in FIG. 1. Therefore, the brightness adjustment and the boundary brightness compensation executed by the control unit of the present embodiment also need to be different from the embodiment illustrated in FIG. 4.

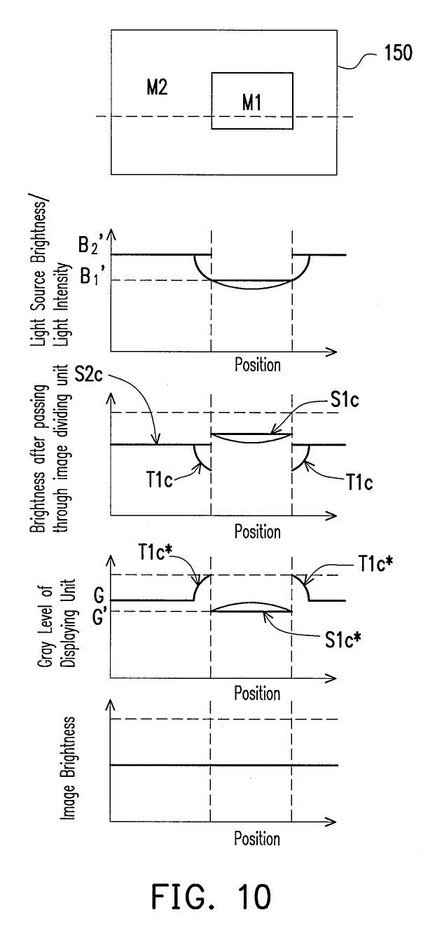

FIG. 10 illustrates an adjustment of image brightness executed by a control unit depicted in FIG. 9. Referring to FIGS. 9 and 10, in the embodiment, a second average brightness B₂′ is higher than a first average brightness B₁′, and the boundary brightness compensation executed by a control unit 170c comprises increasing the gray level of the boundary of the 2D image adjacent to the 3D image from G to the gray level represented by a curve T1c*. Since the curve T1c* is the curve T1c flipped upside down, the curve T1c* may be used to compensate the curve T1c. In the embodiment, the control unit 170c employs a gamma conversion of a gamma value less than 1 to increase the gray level of the boundary of the 2D image adjacent to the 3D image.

Moreover, in the embodiment, the control unit 170c may also lower the gray level of the 3D image, for example by lowering the gray level from G to G′. Accordingly, a line segment S1c* may be used to compensate a line segment S1c. After the afore-described boundary brightness compensation, the two mode image displaying apparatus 100c can effectively reduce the boundary brightness difference between the 2D output image and the 3D output image, and thereby provide an output image with a uniform overall brightness. However, in another embodiment, if the first average brightness B₁′ and the second average brightness B₂′ have been suitably adjusted such that the line segment S1c and the line segment S2c are substantially on a same horizontal line, then the control unit may not be required to lower the gray level of the 3D image, and thus the gray level of the 3D image is maintained at G.

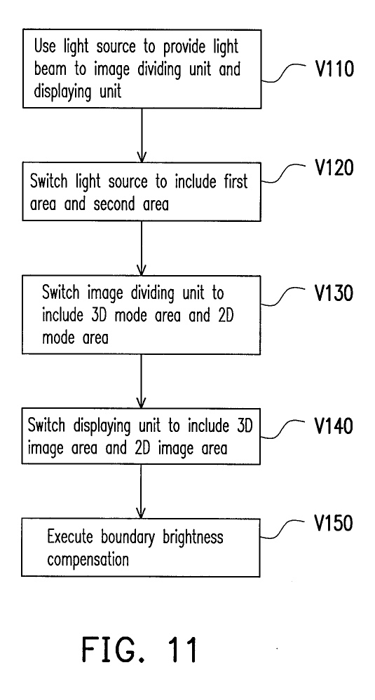

FIG. 11 is a flow chart illustrating an adjustment method of image brightness according to an embodiment of the disclosure. Referring to FIGS. 1 and 11, the adjustment method of image brightness in the present embodiment is adapted for the two mode image displaying apparatus 100 depicted in FIG. 1, as well as the two mode image displaying apparatuses of the other embodiments. The two mode image displaying apparatus 100 is used hereafter as an example for illustration. The adjustment method of image brightness in the present embodiment comprises a Step V110, a Step V120, a Step V130, a Step V140, and a Step V150. In the Step V110, the light source 110 is used to provide the light beam 112 to the image dividing unit 150 and the displaying unit 160. In the Step V120, the light source 110 is switched to comprise the first area P1 and the second area P2, in which the first area P1 of the light source 110 has a first average brightness B₁, and the second area P2 has a second average brightness B₂. In the Step V130, the image dividing unit 150 is switched to comprise the 3D mode area M1 and the 2D mode area M2. In the Step V140, on the displaying unit 160 a 3D image is displayed in the 3D image area N1, and a 2D image is displayed in the 2D image area N2. In the Step V150, the boundary brightness compensation is executed. For details of the boundary brightness compensation, please refer to the embodiment depicted in FIG. 1 regarding the boundary brightness compensation executed by the control unit 170. Other details of the Steps V110-V140 can be referenced to the description of the embodiment depicted in FIG. 1, hence further description thereof is omitted hereinafter.

In FIG. 11, the Steps V110-V150 are sequentially executed. However, in other embodiments, the Steps V110-V150 may be executed in any other possible order, or a portion of the steps may be simultaneously executed. For example, the order of the Steps V120, V130, and V140 may be chosen from any one of the six possible arrangements. Moreover, the Steps V120, V130, and V140 may be substantially simultaneously executed, or two out of the three steps may be chosen to be simultaneously executed. Alternatively, the Steps V120, V130, V140, and V150 may be simultaneously executed. Further, the Steps V110 and V120 may be simultaneously executed.

In addition, the Steps V110-V150 may be adapted to other afore-described embodiments, and the relevant details may be referenced to the embodiments described above, hence detailed description thereof is omitted hereinafter.

The adjustment method of image brightness in the present embodiment can provide 2D and 3D images which have more uniform brightness, and the adjustment method is capable of lowering the boundary brightness difference between the 2D and 3D output images. Consequently, the user observes images that are more natural and comfortable.

In view of the foregoing, according to embodiments of the disclosure, the two mode image displaying apparatus and the adjustment method of image brightness employ boundary brightness compensation, and therefore the boundary brightness difference between the 2D and 3D output images can be effectively reduced. Moreover, the brightness of the 2D and 3D output images are more uniform. Thereby, the user observes images that are more natural and comfortable.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A two mode image displaying apparatus, comprising:
a light source adapted to provide a light beam;
an image dividing unit disposed on a transmission path of the light beam, wherein the image dividing unit is adapted to be switched to comprise a three-dimensional (3D) mode area and a two-dimensional (2D) mode area, the light source is adapted to be switched to comprise a first area corresponding to the 3D mode area and a second area corresponding to the 2D mode area, the first area has a first average brightness, the second area has a second average brightness, and the first average brightness is not equal to the second average brightness;
a displaying unit disposed on the transmission path of the light beam, wherein the displaying unit is adapted to display a 3D image in a 3D image area, and to display a 2D image in a 2D image area, the 3D image area corresponds to the 3D mode area, and the 2D image area corresponds to the 2D mode area; and
a control unit electrically connected to the light source, the image dividing unit, and the displaying unit, wherein the control unit executes a boundary brightness compensation by adjusting a brightness of at least one of the boundary of the 3D image area and the 2D image area and the boundary of the first area and the second area, for reducing a boundary brightness difference between a 3D output image and a 2D output image provided by the two mode image displaying apparatus.

2. The two mode image displaying apparatus as claimed in claim 1, wherein the first average brightness is higher than the second average brightness, and the boundary brightness compensation executed by the control unit comprises lowering a gray level of the boundary of the 2D image adjacent to the 3D image.

3. The two mode image displaying apparatus as claimed in claim 2, wherein control unit employs a gamma conversion of a gamma value greater than 1 to lower the gray level of the boundary of the 2D image adjacent to the 3D image.

4. The two mode image displaying apparatus as claimed in claim 2, wherein an area of the first area is smaller than an area of the 3D mode area, and the boundary brightness compensation executed by the control unit comprises increasing a gray level of the boundary of the 3D image adjacent to the 2D image.

5. The two mode image displaying apparatus as claimed in claim 2, wherein the control unit employs a gamma conversion of a gamma value less than 1 to increase the gray level of the boundary of the 3D image adjacent to the 2D image.

6. The two mode image displaying apparatus as claimed in claim 1, wherein the second average brightness is higher than the first average brightness, and the boundary brightness compensation executed by the control unit comprises increasing the gray level of the boundary of the 2D image adjacent to the 3D image.

7. The two mode image displaying apparatus as claimed in claim 6, wherein the control unit employs a gamma conversion of a gamma value less than 1 to increase the gray level of the boundary of the 2D image adjacent to the 3D image.

8. The two mode image displaying apparatus as claimed in claim 6, wherein the control unit lowers the gray level of the 3D image.

9. The two mode image displaying apparatus as claimed in claim 1, wherein the boundary brightness compensation executed by the control unit comprises lowering a brightness of the boundary of the second area adjacent to the first area to be slightly lower than the second average brightness, and increasing a brightness of the boundary of the first area adjacent to the second area to be slightly higher than the second average brightness.

10. The two mode image displaying apparatus as claimed in 1, wherein the light source comprises a self-luminescent device array.

11. The two mode image displaying apparatus as claimed in 10, wherein the self-luminescent device array is a pixelized self-luminescent device array.

12. The two mode image displaying apparatus as claimed in 10, wherein the self-luminescent device array comprises a light emitting diode array, an organic light emitting diode array, or a plasma display unit array.

13. The two mode image displaying apparatus as claimed in claim 1, wherein the image dividing unit comprises polymer dispersed liquid crystals or polymer network liquid crystals.

14. The two mode image displaying apparatus as claimed in claim 1, wherein the control unit is adapted to dynamically adjust positions and sizes of the 3D mode area and the 2D mode area, and to correspondingly adjust positions and sizes of the first area, the second area, the 3D image area, and the 2D image area.

15. An adjustment method of image brightness, comprising:
using a light source to provide a light beam to an image dividing unit and a displaying unit;
switching the image dividing unit to comprise a 3D mode area and the 2D mode area;
displaying on the displaying unit a 3D image in a 3D image area and a 2D image in a 2D image area, wherein the 3D image area corresponds to the 3D mode area, and the 2D image area corresponds to the 2D mode area;
configuring a first area of the light source to have a first average brightness and configuring a second area of the light source to have a second average brightness, wherein the first area corresponds to the 3D mode area, the second area corresponds to the 2D mode area, and the first average brightness is not equal to the second average brightness; and
executing a boundary brightness compensation by adjusting a brightness of at least one of the boundary of the 3D image area and the 2D image area and the boundary of the first area and the second area, for reducing a boundary brightness difference between a 3D output image and a 2D output image outputted by the light source, the image dividing unit, and the displaying unit as a whole.

16. The adjustment method as claimed in claim 15, wherein the first average brightness is higher than the second average brightness, and the boundary brightness compensation comprises lowering a gray level of the boundary of the 2D image adjacent to the 3D image.

17. The adjustment method as claimed in claim 16, wherein the step of lowering the gray level of the boundary of the 2D image adjacent to the 3D image comprises employing a gamma conversion of a gamma value greater than 1 to lower the gray level of the boundary of the 2D image adjacent to the 3D image.

18. The adjustment method as claimed in claim 16, wherein an area of the first area is smaller than an area of the 3D mode area, and the boundary brightness compensation comprises increasing a gray level of the boundary of the 3D image adjacent to the 2D image.

19. The adjustment method as claimed in claim 18, wherein the step of increasing the gray level of the boundary of the 3D image adjacent to the 2D image comprises employing a gamma conversion of a gamma value less than 1 to increase the gray level of the boundary of the 3D image adjacent to the 2D image.

20. The adjustment method as claimed in claim 15, wherein the second average brightness is higher than the first average brightness, and the boundary brightness compensation comprises increasing the gray level of the boundary of the 2D image adjacent to the 3D image.

21. The adjustment method as claimed in claim 20, wherein the step of increasing the gray level of the boundary of the 2D image adjacent to the 3D image comprises employing a gamma conversion of a gamma value less than 1 to increase the gray level of the boundary of the 2D image adjacent to the 3D image.

22. The adjustment method as claimed in claim 20, further comprising lowering a gray level of the 3D image.

23. The adjustment method as claimed in claim 15, wherein the boundary brightness compensation comprises lowering a brightness of the boundary of the second area adjacent to the first area to be slightly lower than the second average brightness, and increasing the brightness of the boundary of the first area adjacent to the second area to be slightly higher than the second average brightness.

24. The adjustment method as claimed in claim 15, further comprising dynamically adjusting positions and sizes of the 3D mode area and the 2D mode area, and correspondingly adjusting positions and sizes of the first area, the second area, the 3D image area, and the 2D image area.
